(19) United States
(12) Patent Application Publication
(10) Pub. No.: US 2008/0025654 A1
(43) Pub. Date: Jan. 31, 2008

(54) Rolling Groove with Combined Curve Profile for Linear Guide Way

(76) Inventor: Chang-Hsin Kuo, Taichung (TW)

Correspondence Address: HDSL, 4331 STEVENS BATTLE LANE, FAIRFAX, VA, 22033, US

(21) Appl. No.: 11/864,908

(22) Filed: Sep. 29, 2007

Related U.S. Application Data
(63) Continuation-in-part of application No. 11/102,675, filed on Apr. 11, 2005, now abandoned.

(51) Int. Cl. F16C 29/06

(52) U.S. Cl. 384/45

(57) ABSTRACT

A rolling groove with combined curve profile for linear guide way in which the cross section profile of the rolling groove is formed of three successively and tangentially contacted circular arcs. The ratio of radius of curvature of the intermediate arc to the radius of ball is made approaching to 1, while the radii of curvature of arcs at both sides are larger that of the intermediate one. By so, the design of the present invention can achieve a sufficient load carrying capability and provide an optimistic self-aligning effect as well for the linear guide way so as to prevent the traveling ball from being in contact with the edge of the rolling groove.

### RELATED APPLICATIONS

This application is a continuation-in-part of U.S. patent application Ser. No. 11/102,675, filed on Apr. 11, 2005.

### BACKGROUND OF THE INVENTION

1. Field of the Invention

The present invention relates to a rolling groove with combined curve profile for linear guide way, and more particularly, to a specially constructed rolling groove for linear guide way, wherein the rolling groove, is constructed in such a way that its profile is a combination of several arcs so as to permit the balls rolling therein to have a good contact with the rolling groove.

2. Description of the Prior Art

So far, a linear guide way is widely used in the field of precision machines, automation industry, semiconductor industry, medical apparatus, aerospace industry etc. The frictional resistance in this apparatus during operation is reduced by the balls rolling in the rolling groove so as to contribute to creation of many merits such as saving energy, alleviating machine abrasion, lowering temperature rise, prolonging the machine durability, improving working efficiency and machining precision etc.

An exemplary conventional linear guide way for ordinary use is shown in FIG. 4. It includes a guide rail 1, a slider 2, and a plurality of balls 3. The guide rail 1 is of a long bar shape along which a rail rolling groove 11 is formed extending longitudinally. The slider 2 that is engaged with the guide rail 1 has a slider rolling groove 21 in correspondence with the rail rolling groove 11. The balls 3 are interposed between the two rolling grooves 11 and 21 and travel in the longitudinal direction of the guide rail 1. For the convenience of illustration, the rail rolling groove 11 and the slider rolling groove 21 will be combined to call “rolling groove” hereinafter. Circulation holes 22 provided on the slider 2 are for the balls 3 to return so that the balls 3 may circulate between the rolling grooves and the circulation holes 22. The ordinary linear guide ways classified by number of ball rows, generally there are two-row type and four-row type. Evidently the one shown in FIG. 4 is a four-row type. It is noticed that the four-row type linear guide way whose rolling groove being constructed to have a single arc cross section remains a broader relative displacement space for the balls traveling along the rolling groove to achieve necessary “self-aligning”.

FIG. 5 is a schematic cross sectional view of a conventional rolling groove. The profile thereof, which is the profile of the cross section either the rail rolling groove 11 or the slider rolling groove 21, forms a single arc AB wherein the hatched area is a fragmentary enlarged portion near the rolling groove of a linear guide way. A and B are two terminal points of arc AB, and O is the center of curvature of arc AB. P is the center of circle P which represents the profile of a ball. Circle P and arc AB are tangent to each other at point T, which locates at the center of arc AB. Here, assume the radius of curvature of arc AB is K times that of circle P, where K is about 1.02-1.12. In case the radius of circle P is R, the radius of curvature of arc AB will be KR, while the distance of point O to point P is (K−1)R. Point Q represents the position of center of circle P when it moves to the right along the rolling groove (arc AB) until being tangent to arc AB at point B, at this time the horizontal distance between point Q and point P is nR, and angle TOB is α. According to applied geometry, it is obtained
Sin α=n/(k−1), or n=(k−1)*sin α

Here, n is a ratio of allowable displacement of a ball for traveling (self-aligning) between point P and pint Q on arc AB to the radius of the ball. Generally, all the self-aligning effect and load carrying capability are important to a linear guide way. Therefore, K is generally maintained at a value larger than 1 but very close to 1 so as to maximize the allowable contact area between the ball and the rolling groove thereby improving load carrying capability of the linear guide way. Meanwhile, it is problematic that if K approaches 1, (K−1) approaches zero, which means that the aforesaid contact area between the ball and the rolling groove is minimized by giving the value of or only about 30°, and bringing n to approach zero that results in a very poor self-aligning effect. For example, if K=1.02, α=30°, then n=0.01, which means allowable self-aligning range is remained only 1/100 of the length of the radius of ball.

It should be understood that owing to the existing limitation on the machine design, the angle AOB (see FIG. 5) is made about 60°, in this case, when α=30°, the ball will contact the edge of the rolling groove (point B in FIG. 5), and a poor operation of the linear guide way will result.

For this defect noticeable on the prior art, an improvement is seriously required for a linear guide way to optimize its self-aligning effect and load carrying capability.

### SUMMARY OF THE INVENTION

The present invention is to provide a linear guide way with a rolling groove having a sufficient load carrying capability and a good self-aligning possibility so as to prevent the ball from contacting the edge portion of the rolling groove.

To achieve the above object, the present invention provides a rolling groove whose profile is constructed by at least three arcs tangentially connected with adjacent ones, and the ratio of the radius of curvature of the intermediate arc to the radius of the ball is made approaching to 1, whereas the radii of curvature of the arcs formed at both sides are larger than that of the intermediate one.

For increasing the load carrying capability of a linear guide way, generally the radius of curvature of the intermediate arc is made 1˜1.05 times the radius of the ball.

For achieving an optimistic self-aligning effect, the curvature of the arcs at two sides have to be slightly larger than that of the intermediate one, generally, the formers are designed to have the value 1.08˜1.20 times the radius of ball.

For improving both the self-aligning effect and the load carrying capability, the center angle of the intermediate arc (2α) is made at 35°˜50°.

In proof of the innovative and technological content of the invention herein, please refer to the detailed description of the embodiment and the accompanying brief description of the drawings appended below. Furthermore, the drawings and embodiment are provided for purposes of reference and explanation, and shall not be construed as limitations applicable to the invention herein.

### BRIEF DESCRIPTION OF THE DRAWINGS

FIG. 1 is a schematic cross sectional view of the linear guide way rolling groove according to the present invention;

FIG. 2 is a geometrical illustration to FIG. 1;

FIG. 3 is graph plotted (n+m) vs. j;

FIG. 4 is a perspective view of a typical linear guide way; and

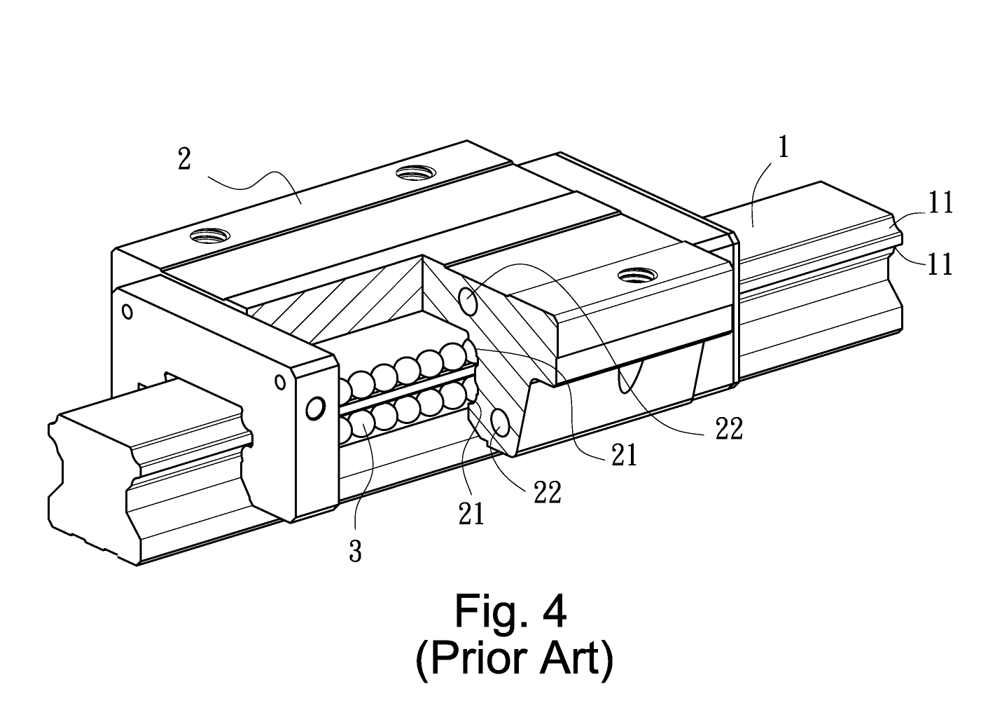

FIG. 5 is a schematic cross sectional view of a conventional linear guide way rolling groove.

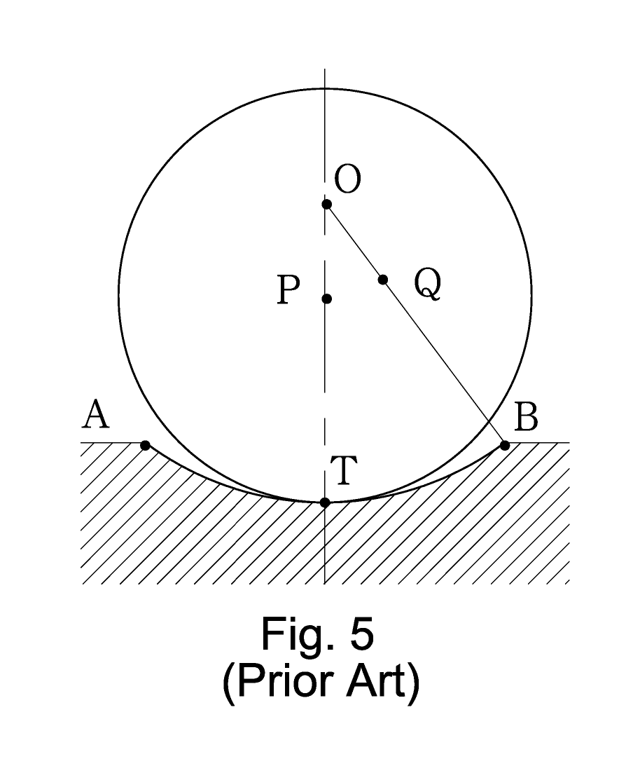

### DETAILED DESCRIPTION OF THE PREFERRED EMBODIMENT

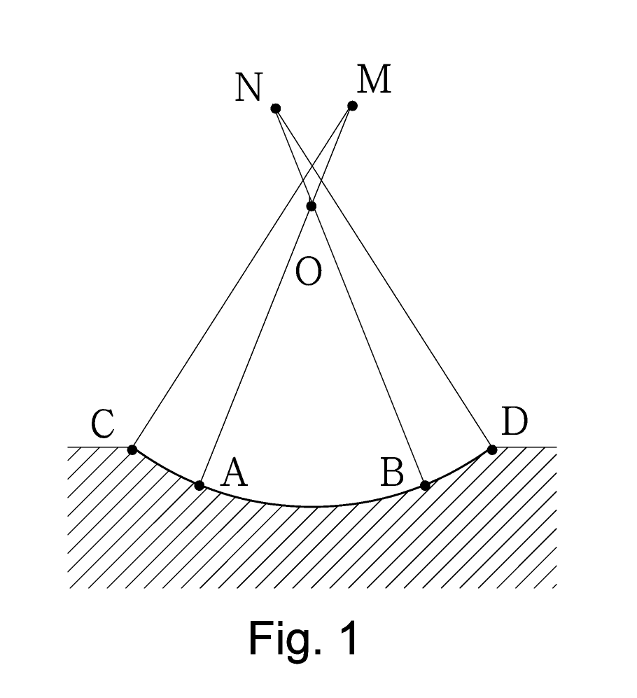

FIG. 1 is a schematic cross sectional view of the linear guide way rolling groove according to the present invention. The hatched area represents a fragmentary enlarged portion of the guide way and the rolling groove, wherein the cross sectional profile of the rolling groove is formed of three successively connected arcs CA, AB, and BD. Arc AB ends at point A and point B, and point O is the center of curvature of arc AB. On the other hand, arc BD ends at point B and pint D, and point N is the center of curvature of curvature of arc BD. Arc CA ends at point C and point A, and point M is the center of curvature of arc CA. Arc CA and arc BD are respectively located at the left and right sides of arc AB, arc BD is tangent to the arc AB at point B, arc CA is tangent to arc AB at point A. Since the radii of arc BD and arc CA are both larger than that of arc AB, the center N of arc BD locates at the left upper side of the point O, and furthermore points N, O, B are on a common straight line. On the other hand, the center M of arc CA locates at the right upper side of point O, and points M,O,A are on a common straight line.

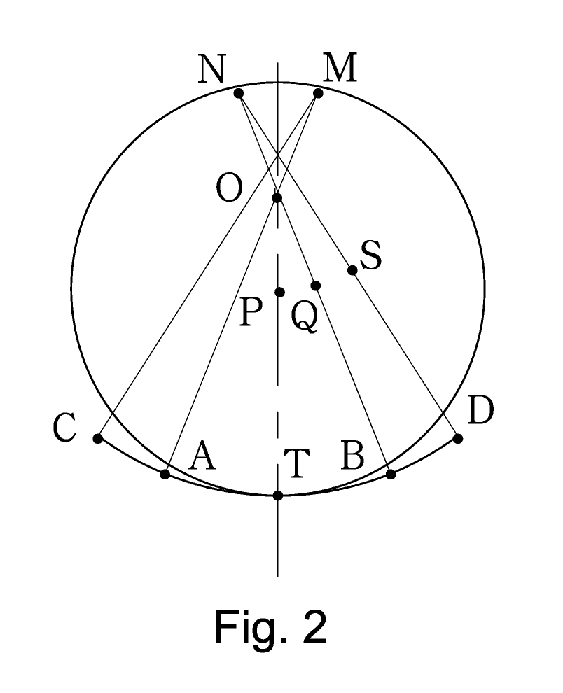

The geometrical explanation to FIG. 1 can be illustrated by FIG. 2. Wherein circle P represents the profile of a ball, and circle P is tangent to arc AB at its middle pint T. Assuming the radius of curvature of arc AB is K times as large as radius of circle P, in this case, if radius of circle P is R, then radius of curvature of arc AB will be (KR), and the distance from O. to P is (K−1)R. When circle P rolls to the right along the rolling groove (arc AB) until tangentially contacts arc AB at point B, the center of circle P will be removed to point Q as shown in FIG. 2. Assuming the horizontal distance from point Q to P is nR, and angle TOB equals to or, which is half of the center angle of the intermediate arc AB. The following equation can be easily derived by applied geometry similar to the conventional case:
sin α=n/(k−1) or n=(k−1)·sin α

As arc CA and arc BD are respectively tangent to arc AB on point A from the left side, and tangent to arc AB on point B from the right side, if circle P moves along the rolling groove (arc AB) with a horizontal distance nR to reach point B bringing its center to point Q, and continue to advance to the right side along the rolling groove, circle P will move entering arc BD by passing point B, where arc AB and arc BD are tangentially contacted with each other, and reach a point D where circle P is tangentially in contact with arc BD, the center of circle P will be removed to point S as shown in FIG. 2. Assuming the horizontal distance from point Q to pint S is m times of R, e.g. mR, angle BND is β, and the radius of curvature of arc BD is j times the radius of circle P, then we obtain
mR=(j−1)R·[sin(α+β)−sin α]
and the horizontal distance from pint P to pint S is

$$\begin{matrix}n R + m R = ( j - 1 ) R \cdot [ sin ( α + β ) - sin α ] + ( k - 1 ) R \cdot sin α \\ = ( j - 1 ) R \cdot sin ( α + β ) + ( k - j ) R \cdot sin α\end{matrix}$$
where the ratio of the horizontal distance between P and S to the radius of the ball will be n+m=(j−1)·sin(α+β)+(k−j)·sin α

In general, the rolling groove encircles the ball at a range about 60° which makes (α+β)=30°. In order to achieve a reliable load carrying capability for the rolling groove, the value K, which is the ratio of the radius of curvature of arc AB to the radius of circle P (e.g. ball) may be designed to be nearly equal to 1. As the radii of curvature of arcs at both sides are larger than that of the intermediate arc, by letting α=20° (angle TOB), then the center angle of the intermediate arc will be 40°, and β=10°. By letting k=1, j=1.20, substitute these values into the above formula, we obtain
n+m=0.0316

If α=20°, β=10°, k=1.05, j=1.08, this time we obtain
n+m=0.0297
Such self-aligning effect is significantly more optimistic than the value 0.010 obtained by the prior art by letting α=30°, k=1.02.

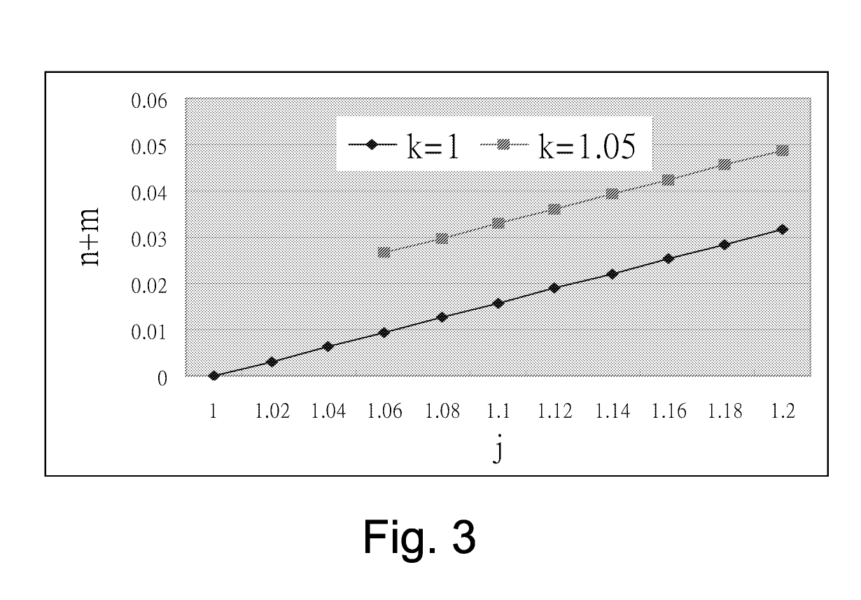

FIG. 3 is a graph plotted (n+m) vs. j by varying values of K and j against holding α=20°, β=10° at constant. It is clear from FIG. 3 that the value of (n+m) increases approximately linearly with respect to increase of the value j. However, an excessively large value of j will cause degradation of the linear guide way load carrying capability when the ball is loading on the rolling groove corresponding to the region of arc BD. Accordingly, j is preferably designed at the value 1.08˜1.20. On the other hand, the value of K affects the load carrying capability when the ball is loading on the rolling groove corresponding to the region of arc AB. If K is excessively large, even a sufficiently large self-aligning effect can be obtained by applying conventional design without need of the present invention. But in order to prevent degradation of the load carrying capability, in the present invention, it is recommended that k is preferably set at 1˜1.05.

In all, the cross sectional profile of the rolling groove according to the present invention is formed of three successively and tangentially contacted circular arcs. The ratio of radius of curvature of the intermediate arc to the radius of ball is made approaching to 1, while the radii of curvature of arcs at both sides are larger than that of the intermediate arc. By so, the design of the present invention can achieve a sufficient load carrying capability and provide an optimistic self-aligning effect as well for the linear guide way so as to prevent the traveling ball from being in contact with the edge of the rolling groove.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A linear guide way comprising:
a guide rail being of a long bar shape along which a rail rolling groove is formed extending longitudinally;
a slider engaged with the guide rail, having a slider rolling groove in correspondence with the rail rolling groove, the slider and the rail rolling grooves being combined as a rolling groove with a combined curve profile; and
a plurality of balls interposed in the rolling groove and traveling in a longitudinal direction of the guide rail, a plurality of circulation holes being provided on the slider for the balls to return so that the balls circulate between the rolling groove and the circulation holes,
wherein each of the slider and the rail rolling grooves is formed of three successively and tangentially contacted circular arcs, and
wherein an intermediate arc of the three arcs has a radius of curvature approaching to the radius of the ball, while radii of curvature of arcs formed at two sides are larger than that of the intermediate arc, and a center angle of the intermediate arc is equal or larger than 35° and less than 50°,
wherein the radius of curvature of the intermediate arc is 1 to 1.05 times that of the ball so as to improve the load carrying capability of the linear guide way, and wherein the radii of curvature of the two side arcs are 1.08 to 1.20 times that of the ball so as to offer the linear guide way an optimistic self-aligning effect.
